(19) United States
(12) Patent Application Publication
(10) Pub. No.: US 2016/0110663 A1
(43) Pub. Date: Apr. 21, 2016

(54) SYSTEM AND METHOD FOR PRODUCING SUITABILITY SCORE FOR ENERGY MANAGEMENT SYSTEM ON BUILDING ROOFTOP

(71) Applicants: Ryan Craig Miller, Deephaven, MN (US); David S. Herrmann, Castle Rock, CO (US); Sun Number, LLC, Denver, CO (US)

(72) Inventors: Ryan Craig Miller, Deephaven, MN (US); David S. Herrmann, Castle Rock, CO (US)

(21) Appl. No.: 14/517,790

(22) Filed: Oct. 17, 2014

(51) Int. Cl. G06Q 10/06

(52) U.S. Cl. CPC G06Q 10/0631

(57) ABSTRACT

System and method are disclosed for producing a suitability score for installation of an energy management system on a building rooftop. In one embodiment, insolation data is obtained for geographic regions, including geographic region where building rooftop is located. A plurality of solar potential data sets for each geographic region are provided to obtain an insolation impact value for each of the solar potential data sets. The insolation impact value is calculated for each solar potential data set. The impact of the physical characteristics of the building rooftop on insolation is calculated. A threshold score above which the building rooftop is suitable for installation of the energy management system is assigned.

### BACKGROUND OF THE INVENTION

1. Field of the Invention

The present invention relates to a system and method for producing a suitability score for the installation of an energy management system, and particularly installation of an energy management system on the rooftop of an existing building.

2. Description of the Related Art

At present, there has been a significant amount of capital, research and development devoted to harnessing radiant light and heat from the sun for the purpose of producing electrical energy for human consumption. The field of solar energy potential continues to grow and progress each year. As technologies improve and the cost of energy management systems decreases, the potential for a greater number of private individuals and organizations to use such technology substantially increases. Unfortunately, methods for estimating solar potential are primarily focused on providing information to individuals within the industry.

At the broadest level, methods for determining solar potential calculate the amount of solar radiation energy on a given surface. These methods take into consideration myriad factors. There are overarching considerations, such as the geometry of the earth and its revolution and rotation about the sun. Local impacts, including landscape elevation, shadow coverage and atmospheric attenuation, need to be accounted for. Finally, the physical characteristics of the subject surface—for example, inclination, orientation and surface area—which must be included in any solar potential estimation. Once these variables are determined, the insolation potential of the subject surface—that is, the total amount of solar radiation energy received—can be calculated.

There are numerous known methods which reliably provide the insolation potential for a surface; however, these methods create insolation potential information in a manner that is not understandable by average consumers of electricity. It would be exceedingly burdensome and labor intensive for an electricity consumer, such as a homeowner, to determine whether purchasing an energy management system would be economically beneficial to him or her using the present means for conveying insolation potential. The inventors are not aware of any other methods presently in use which provide average electric consumers with immediately comprehendible and usable solar energy potential information. Thus, a system and method for producing a suitability score for installation of an energy management system on a building rooftop, solving the aforementioned problems, is desired.

### SUMMARY OF THE INVENTION

A system and method are disclosed for producing a suitability score for installation of an energy management system on a building rooftop. In one embodiment, insolation data is obtained for multiple geographic regions, including a geographic region in which the building rooftop is located. A plurality of solar potential data sets for each selected geographic region are provided to obtain an insolation impact value for each of the solar potential data sets. Next the insolation impact value is calculated for each solar potential data set. The impact of the physical characteristics of the building rooftop on insolation is then calculated. Finally, a threshold score, above which the building rooftop is suitable for installation of the energy management system, is assigned.

A

### BRIEF DESCRIPTION OF THE DRAWINGS

FIG. 1 is a flowchart showing a high-level exemplary embodiment of the present system.

FIG. 2 is a flowchart showing exemplary financial feasibility data that serve as inputs to calculate the economic impact of installation of an energy management system as contemplated in one embodiment of the present system.

FIG. 3 is a sample scoring output produced by one embodiment of the present invention.

Similar reference characters denote corresponding features consistently throughout the attached drawings.

### DETAILED DESCRIPTION OF THE PREFERRED EMBODIMENTS

In various exemplary embodiments, the technology provides methods and systems for producing a score for use in determining the suitability of a building rooftop for the installation of an energy management system utilizing, but not limited to, insolation data, solar potential data, variance analysis and physical characteristics of the subject rooftop.

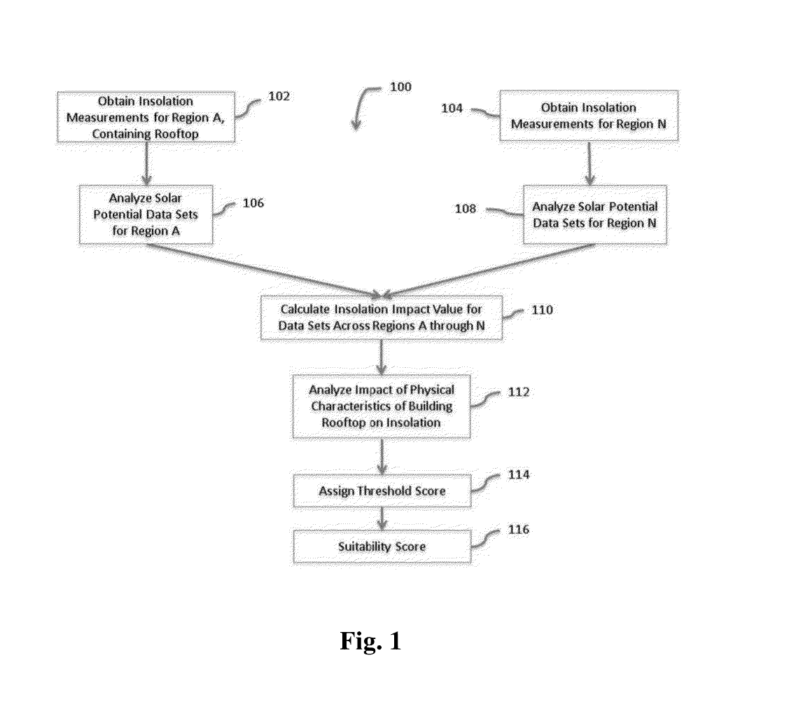

FIG. 1 is a flowchart demonstrating a high-level exemplary embodiment of the invention 100. As illustrated in FIG. 1, insolation measurements are obtained for a geographic region in which the subject rooftop is located (‘Region A’) 102. At step 104, insolation measurements are obtained for a separate geographic region (‘Region N’). Region N represents a final selected region whereby any number of desired intermediate regions between A and N can be designated and insolation measurements can be obtain therefor.

There are numerous know methods for calculating insolation. In addition, insolation measurements can be easily obtained through publicly available sources in the United States. One such source is the National Solar Radiation Database (NSRDB), which is generated by the National Renewable Energy Laboratory (NREL). NREL is the United States' Department of Energy's (DOE) primary national laboratory for renewable energy and energy efficiency research and development. NSRDB provides insolation measurements for numerous locations across a significant period of time. Specifically, NSRDB provides insolation measurements for 1,454 locations in the United States and its territories for the years 1991 to 2010.

Referring still to FIG. 1, at step 106, desired solar potential data sets for Region A are obtained. The same categories of solar potential data are used to create solar potential data sets for Region N 108, and any other selected regions, as previously referenced. In one preferred embodiment, the solar potential data gathered for a given region include climate data and shadow coverage data. Climate data for a given region can be of particular importance with regard to energy management systems—particularly a solar collector systems which use photovoltaics, as contemplated in one preferred embodiment of the invention—because adverse climate conditions can being about changes to the ambient air which would greatly affect insolation. In addition, the presence of weather-related phenomenon, such as clouds, can reduce the efficacy of an energy management system. The effect can be demonstrated by the following equation.

F_{C}=(1−CP)×F₀

wherein F_{C} represent the insolation when clouds are present, CP stands for Clouds Present and represents the amount of cloud and F₀ represent the direct solar radiation or the final diffuse solar radiation on a clear day when there is no cloud cover. Climate data can nonetheless be obtained from NREL for several locations throughout the United States.

One embodiment of the present invention calculates the shadow coverage data by using landscape elevation data derived from, for example, a digital surface model provided by Light Detection and Ranging (LIDAR) for each of the geographic regions. A digital surface model represents the surface of the Earth, or another celestial object, created from terrain elevation data. LIDAR is an established, accurate measurement system. The landscape elevation data can then be ingested into a geographical information system. One preferred embodiment uses the known r.sun solar irradiance and irradiation model for the Geographic Resources Analysis Support System as the geographical information system. Shadow characteristics including, for example, duration of shadow coverage on the building rooftop and percentage of shadow coverage on the building rooftop are then calculated. Finally, the surface area of the building rooftop within the shadow coverage is used to calculate an overall shadow coverage data point.

Continuing with FIG. 1, step 110 involves calculating the impact each category of solar potential data has on the insolation measurements obtained in steps 102 and 104. Calculating the impact of the solar potential data on the insolation data for each region provides the ability to compare suitability across multiple locations. This can be used for comparing suitability across a very large area, such as the United States. Compare suitability across multiple locations also allows for a larger data set that can be used to provide more accurate data if normalized. In one preferred embodiment, the step of calculating the insolation impact value of the solar potential data sets 110 is performed by calculating the variance of each insolation impact value obtained across all of the selected geographic regions to obtain a variance data set for each solar potential data set. Variance data sets are then normalized to a notionally common scale to obtain normalized variance data. One such variance calculation is represented by the following equation

X_{new}=(X−Xₘᵢₙ)/(Xₘₐₓ−Xₘᵢₙ)

wherein X_{new} is the new normalized value, X is the data point being normalized, Xₘᵢₙ is the minimum value of any data point in the set and Xₘₐₓ is the minimum value of any data point in the set. Finally, a preferred embodiment provides for creating a weighted adjustment to the normalized variance data. The weighted adjustment should be calculated using the following equation

SUM(Weight_{A}, . . . , Weight_{N})=1

wherein SUM is the cumulative value for all weights assigned to a dataset, Weight_{A} represents the weight assigned to data set A (the first data set), Weight_{N} is the weight assigned to data set N and N is the total number of data sets.

Step 112 involves calculating the impact of the physical characteristics of the subject building rooftop on insolation. In one preferred embodiment uses the inclination, orientation, and surface area for each section of the building rooftop that has varying values for each of those three characteristics.

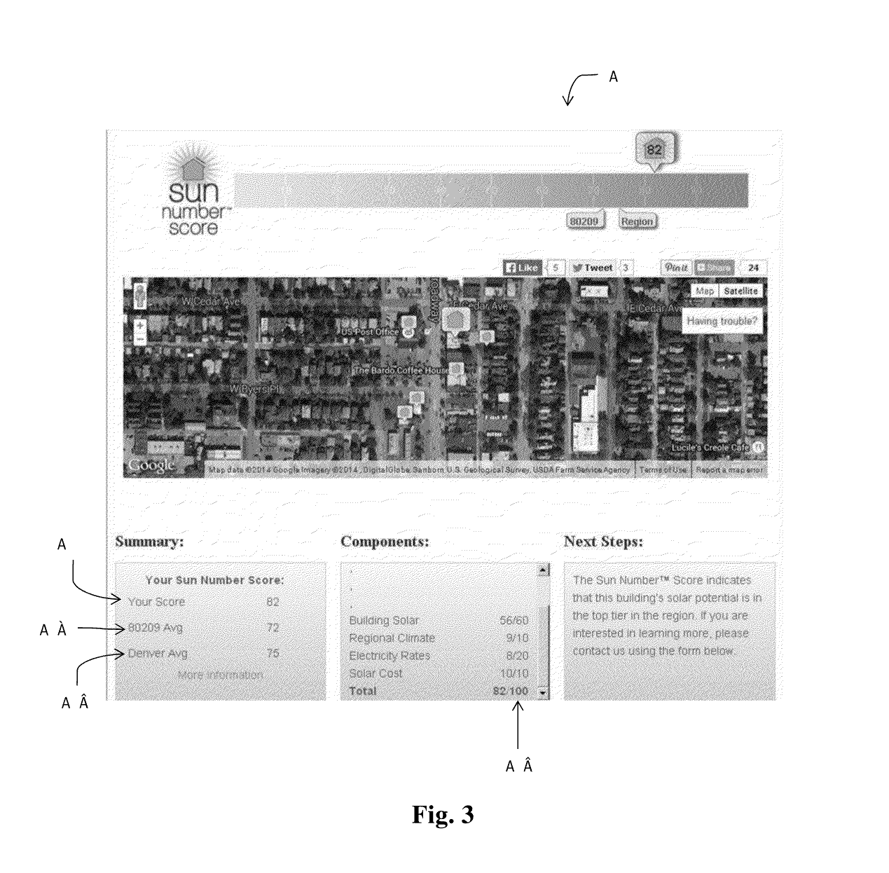

Step 114 involves assigning a threshold score, above which the building rooftop is suitable for installation of the energy management system. The suitability score is calculated and provided in step 116 based upon all of the input data utilized. FIG. 3 is a sample scoring output 300 produced by one embodiment of the present invention demonstrating how the suitability score 302 is provided to an electricity consumer for the subject rooftop together with comparison suitability scores within the same area code as the subject rooftop 304 and within the nearest major metropolitan city 306. In one embodiment of the invention, the suitability score is an integer from 0 to 100, as represented in FIG. 3 306.

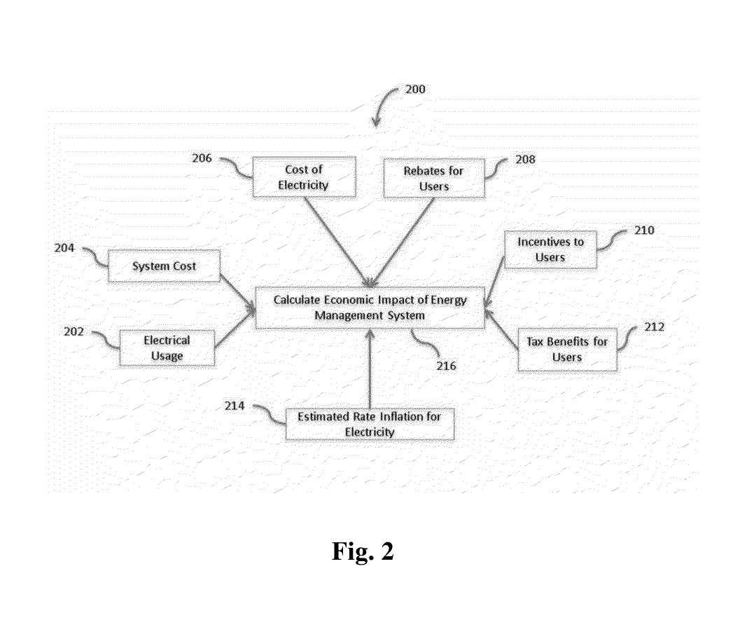

In one preferred embodiment of the present invention, the economic impact of installing the energy management system is included in determining the desirability of the obtaining the energy management system. In such embodiments, a deadline for reimbursement of the costs of the energy management system can be specified. FIG. 2 is a flowchart showing exemplary financial feasibility data that serve as inputs to calculate the economic impact of installation of an energy management system as contemplated in one embodiment of the present invention 200. In embodiment 200, the economic impact data includes the amount of electricity used at the location where the use of an energy management system is contemplated 202, the cost associated with purchasing and installing the energy management system 204, the cost of electricity 206, rebates available to users of energy management systems 208, incentives available to consumers who utilize energy management systems 210, tax benefits for users of energy management systems 212 and energy rate inflation estimation 214.

It should be understood that the invention is not limited in its application to the details of the particular arrangement shown here since the invention is capable of other embodiments, some of which may be quite different from those of the disclosed embodiments. Moreover, a system may be implemented and/or a method practiced using other structural and/or functional details in addition to or other than the structural and/or functional details set forth herein. It should therefore be further understood that the present invention is not limited to the embodiments described above, but encompasses any and all embodiments within the scope of the following claims.

We claim:

1. A method for producing a suitability score for installation of an energy management system on a building rooftop, comprising the steps of:
providing insolation measurements for a plurality of selected geographic regions including a geographic region in which the building rooftop is located;
providing a plurality of solar potential data sets for each of the plurality of selected geographic regions to obtain an insolation impact value for each said plurality of solar potential data sets;
calculating the insolation impact value of each said plurality of solar potential data sets;
calculating impact of physical characteristics of the building rooftop on insolation; and
assigning a threshold score above which the building rooftop is suitable for installation of the energy management system.

2. The method for producing a suitability score for installation of an energy management system on a building rooftop according to claim 1, wherein the plurality of solar potential data sets comprise: climate data and shadow coverage data.

3. The method for producing a suitability score for installation of an energy management system on a building rooftop as recited in claim 2, wherein the shadow coverage data is determined by:
providing landscape elevation data for each of the plurality of selected geographic regions;
entering the landscape elevation data into a geographical information system;
calculating at least one shadow coverage characteristic comprising: duration of shadow coverage on the building rooftop and percentage of shadow coverage on the building rooftop; and
calculating the surface area of the building rooftop within the shadow coverage.

4. The method for producing a suitability score for installation of an energy management system on a building rooftop as recited in claim 2, wherein the shadow coverage data is determined by:
providing landscape elevation data for each of the plurality of selected geographic regions;
entering the landscape elevation data into a geographical information system;
calculating the duration of shadow coverage on the building rooftop;
calculating the percentage of shadow coverage on the building rooftop; and
calculating the surface area of the building rooftop within the shadow coverage.

5. The method for producing a suitability score for installation of an energy management system on a building rooftop as recited in claim 3, wherein the landscape elevation data is a digital surface model derived from LIDAR data.

6. The method for producing a suitability score for installation of an energy management system on a building rooftop as recited in claim 4, wherein the landscape elevation data is a digital surface model derived from LIDAR data.

7. The method for producing a suitability score for installation of an energy management system on a building rooftop as recited in claim 1, further comprising the step of calculating the economic impact the energy management system on the building rooftop using financial feasibility data following the step of calculating impact of physical characteristics of the building rooftop on insolation.

8. The method for producing a suitability score for installation of an energy management system on a building rooftop as recited in claim 7, wherein the financial feasibility data comprises electrical usage, cost of the energy management system, cost of electricity, rebates available to users of energy management systems, incentives available to users of energy management systems, tax benefits for users of energy management systems and an estimated rate inflation for electricity.

9. The method for producing a suitability score for installation of an energy management system on a building rooftop according to claim 1, wherein the step of calculating the insolation impact value of each said plurality of solar potential data sets comprises the steps of:
calculating the variance of each insolation impact value obtained across the plurality of selected geographic regions to obtain a variance data set for each of the plurality of solar potential data sets;
normalizing the variance data sets obtained across the plurality of solar potential data sets to a notionally common scale to obtain normalized variance data; and
applying a weighted adjustment to the normalized variance data.

10. The method for producing a suitability score for installation of an energy management system on a building rooftop as recited in claim 9, wherein the notionally common scale includes the set of integers from 0 to 100.

11. The method for producing a suitability score for installation of an energy management system on a building rooftop according to claim 1, wherein the physical characteristics of the building rooftop include inclination, orientation and surface area.

12. The method for producing a suitability score for installation of an energy management system on a building rooftop according to claim 1, wherein the energy management system is a solar collector system.

13. The method for producing a suitability score for installation of an energy management system on a building rooftop as recited in claim 12, wherein the solar collector system is a photovoltaic system.

14. The method for producing a suitability score for installation of an energy management system on a building rooftop as recited in claim 12, wherein the solar collector system is a solar hot water system.

15. The method for producing a suitability score for installation of an energy management system on a building rooftop according to claim 1, wherein the suitability score is represented alphanumerically.

16. A system for producing a suitability score for installation of an energy management system on a building rooftop, comprising:
means for providing insolation measurements for a plurality of selected geographic regions including a geographic region in which the building rooftop is located;
means for providing a plurality of solar potential data sets for each of the plurality of selected geographic regions to obtain an insolation impact value for each said plurality of solar potential data sets;
means for calculating the insolation impact value of each said plurality of solar potential data sets;
means for calculating impact of physical characteristics of the building rooftop on insolation; and
means for assigning a threshold score above which the building rooftop is suitable for installation of the energy management system.
